(19) United States
(12) Patent Application Publication
(10) Pub. No.: US 2026/0322602 A1
(43) Pub. Date: Oct. 15, 2026

(54) Private On-Premise Multi-Function Artificial Intelligence Server System

(71) Applicants: Alessandro Zanetti, Fort Lauderdale, FL (US); Luca Zanetti, Fort Lauderdale, FL (US); Silvia Fioravanti, Fort Lauderdale, FL (US)

(72) Inventors: Alessandro Zanetti, Fort Lauderdale, FL (US); Luca Zanetti, Fort Lauderdale, FL (US); Silvia Fioravanti, Fort Lauderdale, FL (US)

(21) Appl. No.: 19/390,486

(22) Filed: Nov. 15, 2025

Related U.S. Application Data
(60) Provisional application No. 63/788,770, filed on Apr. 14, 2025.

(51) Int. Cl. H04L 9/08; H04L 9/40

(52) U.S. Cl. CPC H04L 9/0894; H04L 63/105

(57) ABSTRACT

A private, on-premises artificial-intelligence server system configured to execute multimodal AI models locally, integrate a secure database, manage user interfaces, coordinate robotic and automation systems, host multiple AI agents, and selectively interface with external large language models (LLMs) and network resources upon owner authorization. The system provides home, business, enterprise, educational, and defense automation with strict data-ownership guarantees. The architecture implements modular AI pipelines, retrieval-augmented generation containers, device drivers, and multi-layer access controls to ensure privacy-preserving decision-making within secure environments.

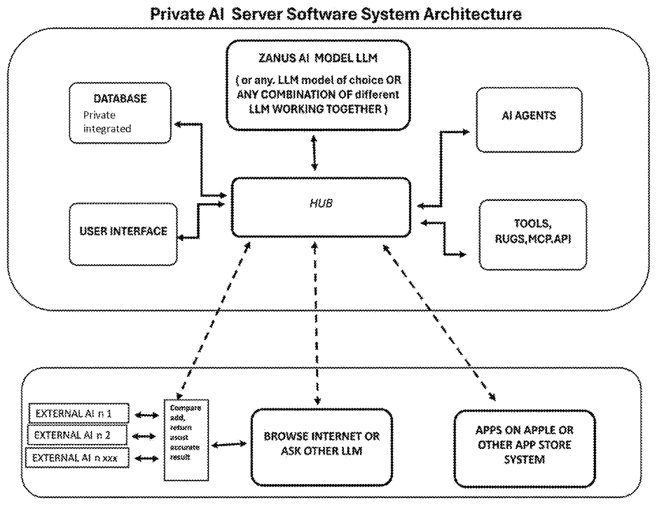

### CROSS REFERENCE TO RELATED APPLICATIONS

This application claims priority from a U.S. Provisional Patent Appl. No. 63/788,770, filed on Nov. 19, 2025, which is incorporated herein by reference in its entirety.

### FIELD OF THE INVENTION

The invention relates to artificial-intelligence computing platforms and, more specifically, to a locally hosted, privacy-preserving AI server that provides in-house intelligent automation, robotics and device orchestration, and decision-support across domestic, business, educational, and defense domains.

### BACKGROUND OF THE INVENTION

Many current AI solutions are offered as remote, subscription-based cloud services. In such arrangements, user prompts, documents, sensor feeds, and operational data are transmitted to third-party infrastructure for processing. This can expose sensitive information and trade secrets, and may also create long-term dependence on external vendors and recurring fees.

For certain categories of users—such as law firms, medical practices, financial institutions, defense organizations, or privacy-conscious households—sending confidential information to remote servers is unacceptable or heavily regulated. Even where encryption is used, the inability to audit or physically control third-party hardware raises concerns about data retention, re-use, or unauthorized analysis.

Existing on-premise AI deployments are often ad hoc, involving a combination of separate database servers, inference engines, and automation controllers that are not architected as a unified privacy-focused product. There is therefore a need for a dedicated private AI server system that behaves as an in-house AI appliance, delivering the convenience of cloud AI while keeping data, models, and execution fully under the owner's control.

### SUMMARY OF THE INVENTION

The present invention provides a private, on-premises AI server system that is installed and operated entirely within a user's premises, such as a residence, office, enterprise facility, or secure governmental site. The system includes one or more processing units, encrypted local storage, an integrated live database, and software components implementing an AI core, a retrieval-augmented generation container, a device and robotics integration framework, and a role-based security kernel.

The AI core may host one or more local language and vision models, decision engines, and reinforcement-learning agents. In some embodiments, a multi-LLM orchestration engine is provided that can, when permitted by the owner, establish an outbound connection to external LLMs, obtain candidate responses, compare those responses against each other and against local context, and return a consolidated result to the user. In default configurations, however, the system is capable of operating without any external network connectivity.

Functional layers may be defined for home automation, business and enterprise automation, educational assistance, and defense or mission-planning support. Each layer can expose specialized tools—such as calendar, document-generation, robotic control, or monitoring—that are implemented as software or AI agents running on top of the core server.

The system is packaged as a deployable private AI server that can replace or supplement subscription-based cloud AI services, giving the owner a permanent, in-house AI capability with full data ownership and the ability to regulate any interaction with external networks.

### BRIEF DESCRIPTION OF THE DRAWING

The drawing shows an overview of the system, according to an exemplary embodiment of the present invention.

### DETAILED DESCRIPTION

In one embodiment, the private AI server is implemented as a rack-mountable or desktop appliance including a multi-core CPU, one or more GPUs or NPUs, non-volatile solid-state storage, and a network interface controller. Secure boot and hardware-backed encryption keys may be employed to ensure that only trusted firmware and operating systems are executed.

The system runs an operating system that hosts an AI core service. The AI core service provides model-loading, inference, and scheduling capabilities for a plurality of AI models. These can include large language models, code-generation models, vision models, audio-processing models, and reinforcement-learning policies. The AI core can route requests among models, combine outputs, and maintain conversational or task context.

A local database is integrated with the core and may store structured data such as user profiles, access rules, equipment inventories, logs, time-series sensor measurements, and historical interactions. The database can be queried directly by the AI core or via a retrieval-augmented generation container that indexes both structured and unstructured content.

The retrieval-augmented generation container may ingest documents from file shares, document-management systems, and enterprise software, and build embeddings or other indices that allow the AI core to answer questions with grounding in the stored material. Because the indices and raw documents are stored entirely on the local server, retrieval can be performed without exposing internal documents to outside infrastructure.

An integration framework exposes connectors and drivers for physical and virtual devices. Examples include IoT hubs, lighting controllers, thermostats, security cameras, access-control systems, industrial machinery, humanoid robots, drones, and smart vehicles. The server can send commands, receive telemetry, and implement closed-loop control policies based on AI logic and user-defined constraints.

In certain configurations, the private AI server is installed as a central hub for a home or building. User interfaces may include web dashboards, mobile applications, voice-assistant terminals, or dedicated control panels. Multiple users can be defined, each associated with profiles that specify permitted devices, data scopes, and AI capabilities.

In business or enterprise deployments, the server may be integrated with existing software such as email systems, customer-relationship-management platforms, accounting software, or inventory-management tools. The AI can automatically draft documents, summarize communications, prepare reports, and propose actions while respecting role-based access rules.

In defense or high-security deployments, the server may be located within a controlled facility and operated with no direct internet connectivity. Updates to models or software may be applied via removable media that are vetted and scanned prior to installation. The AI may be used for mission planning, logistics optimization, simulation, and intelligence analysis, with all sensitive data processed and stored internally.

The security kernel enforces encryption of data at rest and in transit. All external connections—if enabled—are established using authenticated, encrypted channels. A role-based access-control system defines categories such as superuser, owner, administrator, manager, employee, and guest. Each category is associated with capabilities that govern which devices and datasets may be accessed, which AI tools may be invoked, and whether, and under what circumstances, outbound connections to external LLMs or services are allowed.

In some embodiments, a multi-LLM orchestration engine is provided. When a user or subsystem requests external assistance, the engine can query two or more remote LLM services, receive candidate outputs, score those outputs using internal validators or consistency checks, and select or synthesize a final answer. The original prompts, intermediate results, and scores are retained locally to avoid creating external behavioral profiles.

A learning and adaptation module monitors outcomes of AI-driven actions and user feedback. For example, when the server controls HVAC and lighting, it can infer user comfort preferences and energy-saving targets over time. When the server assists with business workflows, it can learn which draft documents are accepted or revised by humans and adjust its generation strategies accordingly. Reinforcement-learning algorithms may be employed to optimize long-term reward signals, such as reduced energy consumption, reduced manual workload, or improved system responsiveness.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Improvements and modifications can be made to the foregoing without departing from the scope of the present invention.

The computer readable storage medium may be a non-transitory computer readable storage medium, and the computer readable program code may be executable by a processing circuit.

1-20. (canceled)

21. A private, on-premises artificial intelligence server system, comprising:
one or more processing units including at least one of a central processing unit, graphics processing unit, or neural processing unit;
non-volatile local storage configured to store encrypted data and executable program instructions;
a local database maintained entirely within a user-controlled premises;
an artificial-intelligence core service executed by the one or more processing units, the AI core service configured to load, schedule, and execute a plurality of artificial-intelligence models locally;
a retrieval-augmented generation container coupled to the local database and configured to index locally stored structured and unstructured data and provide retrieved context to the AI core service during inference;
a device and automation integration framework configured to communicate with physical or virtual devices and to issue control commands based on outputs of the AI core service; and
a security kernel enforcing encryption and role-based access control,
wherein the system is configured to perform artificial-intelligence inference and decision-making without requiring transmission of user data to external computing infrastructure.

22. The system of claim 21, wherein the AI core service hosts a plurality of multimodal models including at least one language model, vision model, audio model, or reinforcement-learning model.

23. The system of claim 21, wherein the local database stores at least one of user profiles, access rules, logs, time-series sensor data, device inventories, or historical interactions.

24. The system of claim 21, wherein the retrieval-augmented generation container generates embeddings or indices from locally stored documents without transmitting the documents off-premises.

25. The system of claim 21, further comprising a multi-LLM orchestration engine configured to:
selectively establish outbound connections to a plurality of external large language model services when authorized;
receive candidate outputs from the external services;
evaluate the candidate outputs using one or more internal scoring or validation mechanisms; and
generate a consolidated response based on the evaluated outputs.

26. The system of claim 25, wherein prompts, intermediate outputs, and evaluation scores associated with the external large language model services are retained exclusively within the local storage.

27. The system of claim 25, wherein outbound connections to external services are disabled by default and enabled only under owner-defined conditions.

28. The system of claim 21, wherein the system is operable with no active internet connectivity.

29. The system of claim 28, wherein updates to software or models are applied via removable media that is validated prior to installation.

30. The system of claim 21, wherein the integration framework communicates with at least one of IoT devices, industrial machinery, access-control systems, robots, drones, vehicles, or building-automation equipment.

31. The system of claim 30, wherein the system implements closed-loop control by issuing commands and receiving telemetry based on AI-generated policies.

32. A method for providing private artificial-intelligence services on-premises, comprising:
executing an AI core service on a locally hosted server within a user-controlled premises;
performing artificial-intelligence inference using locally stored models and data;
retrieving contextual information from a local database using a retrieval-augmented generation container;
generating outputs or control commands based on the retrieved context; and
enforcing encryption and role-based access control such that user data remains under local control.

33. A non-transitory computer-readable storage medium storing program instructions that, when executed by one or more processing units, cause the processing units to perform the method comprising:
executing an AI core service on a locally hosted server within a user-controlled premises;
performing artificial-intelligence inference using locally stored models and data;
retrieving contextual information from a local database using a retrieval-augmented generation container;
generating outputs or control commands based on the retrieved context; and
enforcing encryption and role-based access control such that user data remains under local control.
